(19) United States
(12) Patent Application Publication
(10) Pub. No.: US 2009/0252084 A1
(43) Pub. Date: Oct. 8, 2009

(54) METHOD AND APPARATUS FOR BROADCASTING PUSH-TO-TALK GROUP SESSIONS

(76) Inventors: Gabor Fodor, Hässelby (SE); Ralf Tönjes, Osnabrück (DE)

Correspondence Address: ERICSSON INC., 6300 LEGACY DRIVE, M/S EVR 1-C-11, PLANO, TX, 75024, US

(21) Appl. No.: 11/996,184

(22) PCT Filed: Jul. 18, 2005
(86) PCT No.: PCT/SE05/01166

§ 371 Date: Oct. 15, 2008

(51) Int. Cl. H04W 4/00

(52) U.S. Cl. 370/328

(57) ABSTRACT

The present invention relates to a method of communicating a push-to data packet within a communications system, where the push-to packet originates from a push-to client participating in a push-to user group comprising at least two push-to clients. The method comprises receiving the push-to data packet from a push-to server and broadcasting the push-to data packet over a broadcast distribution network to broadcasting clients which are not part of the push-to user group. A communications interface arranged to communicate push-to data packets, originating from a push-to client participating in a push-to user group comprising at least two push-to clients, from a push-to server to a broadcast node arranged to broadcast the push-to data packets to broadcasting clients which are not part of the push-to user group is also disclosed.

### FIELD OF THE INVENTION

The invention relates to the field of mobile radio communication, and in particular to the field of the push-to services.

### BACKGROUND

Recently, the functionality of mobile radio communication networks has been expanded to include a Push-to-talk (PTT) service, which is a service that facilitates for users of the mobile radio communications network to perform one-way communication with other users in the mobile radio communications network. A PTT user can perform one way voice communication with other PTT users forming a PTT user group. A PTT user group can consist of two or more PTT users, and the members of a PTT user group may vary over time. Within a PTT user group, only one PTT user can talk at a time.

In order to take part in a PTT discussion, a mobile telephone being adapted to PTT services is required, as well as a subscription in a mobile radio network providing a PTT service. Typically, a subscription to the PTT service is also required. When a PTT user finds himself in an area in which there is no radio coverage for his usual mobile radio network, he will not be able to listen to any PTT discussions. A PTT user can choose to never talk, and hence to be a listening user only. However, in order to listen to a discussion held within a PTT user group, a mobile telephone adapted to provide the PTT service is required.

### SUMMARY

A problem to which the present invention relates is the problem of how to enable a person to listen to a PTT discussion without having access to a mobile telephone adapted to PTT services.

This problem is addressed by a method of communicating a push-to data packet within a communications system, the push-to data packet originating from a push-to client participating in a push-to user group comprising at least two push-to clients. The method comprises the steps of

receiving the push-to data packet from a push-to server; and

broadcasting the push-to data packet over a broadcast distribution network (210) to broadcasting clients which are not part of the push-to user group.

By this method is achieved that push-to data packets, such as push-to-talk data packets or push-to-watch data packets, can be broadcasted to broadcasting clients which are not part of the push-to user group and which are not capable of being active in the push-to user group. Hence, activities that take place within a push-to user group can be broadcasted to a large or small number of broadcasting clients, much like a radio or television program.

In one embodiment of the invention the method further comprises the step of

providing the push-to data packet with a priority indication, wherein the priority indication indicates a level of priority which should be given to the push-to data packet when being broadcasted. If a push-to data packet can be given priority over other data packets, in a broadcast node connecting the push-to server to the broadcast distribution network and/or on an interface connecting the push-to server to the broadcast node, transmission delays can be minimised a push-to data packet can be broadcasted in real-time. The priority indication can ensure that push-to data packet, or a burst of push-to data packets, are transported without queuing even when there are other IP packets waiting for transmission in an IP router. The priority indication serves to allow for an IP router to schedule push-to data packets for transmission even when there are other data packets waiting in the router's buffer.

The push-to data packet is advantageously received over a communications interface having a user plane part and a control plane part. In one embodiment of the invention, the method further comprises:

sending an install state message from the control plane part to the user plane part, the install state comprising information about a push-to session of the push-to user group;

installing the session state in the user plane part; and

associating the push-to data packet with the session state.

Hereby is achieved that session dependent information can be used by the user plane part in the communication of the push-to data packet. In this embodiment, the providing of the push-to data packet with a priority indication could comprise the association of the push-to data packet with the session state. Hereby is achieved that different push-to sessions could use different conditions for how to provide a push-to data packet with a priority indication.

The method preferably comprises the steps of

receiving a control message which is related to the broadcasting, the control message being formatted according to a first protocol used by the push-to server for the transmission of control messages and including information about a recipient;

converting the control message into a second control message formatted according to a second transmission protocol used by a broadcast node arranged to broadcast the push-to data packet via the broadcast distribution network; and

sending the second control message to the broadcast node.

Hereby is achieved that control messages relating to the broadcasting can be transmitted between the push-to server and a broadcast node even if the broadcast node uses a different protocol stack than the push-to server. The first protocol could preferably be the Session Initiation Protocol (SIP).

In one embodiment of the invention, the method further comprises the step of checking whether the push-to data packet should be broadcasted. Hereby is achieved that a push-to data packet can be muted for broadcasting, so that a push-to user can rest assured that any information that he does not wish to be broadcasted will only be transmitted to members of the push-to user group.

In one embodiment, the method further comprises the steps of storing the push-to data packet in a storage for push-to data packets upon receipt of the push-to data packet; and the broadcasting comprises retrieving the push-to data packet from the storage. Hereby is achieved that a push-to session can be replayed at a different point in time, which allows inter alia for the editing of the push-to session before the broadcasting of the session.

The problem is further addressed by a control data communication unit having a first port arranged to receive from a first node a first control message formatted according to a first protocol used by the first node for the transmission of control messages; a protocol conversion mechanism arranged to convert the first control message into a second control message formatted according to a second protocol used by a second node for the transmission of control messages; and a second port for sending the second control message to the second node, wherein

the first node is a push-to server;

the control message relates to the broadcasting of a push-to data packet originating from a push-to client participating in a push-to user group comprising at least two push-to clients; and

the second node is a broadcast node arranged to broadcast the push-to data packet to broadcasting clients which are not part of the push-to user group.

The problem is also addressed by a user data communication unit having a first port arranged to receive a user data packet from a first node and a second port arranged to send the user data packet to a second node wherein the user data packet is a push-to data packet originating from a push-to client participating in a push-to user group comprising at least two push-to clients, the first node is a push-to server and the second node is a broadcast node arranged to broadcast the push-to data packet to broadcasting clients which are not part of the push-to user group.

A communications interface arranged to communicate push-to data packets from a push-to server to a broadcast node could advantageously comprise said control data communication unit and said user data communication unit. The control data communication unit could be implemented as part of the push-to server, part of the broadcast node, or as one or several separate entities. The same applies to the user data communication unit.

The problem is further addressed by a mobile station arranged to send push-to data packets to a push-to server for further distribution within a push-to user group. The mobile station comprises a mute mechanism arranged to receive a first instruction that a push-to data packet should not be broadcasted to any broadcast client which is not part of the push-to user group and to send a second instruction to the push-to server that the push-to data packet should not be broadcasted. Hereby is achieved that a push-to data packet can be muted for broadcasting, so that a push-to user can rest assured that any information that he does not wish to be broadcasted will only be transmitted to members of the push-to user group.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a schematic illustration of a mobile radio network providing the PTT service.

FIG. 2 is a schematic illustration of a mobile radio communication system wherein an inventive broadcast interface is provided between a PTT server and a broadcast node, in order to allow for the broadcasting of the discussions held by a PTT user group.

FIG. 3 is a schematic illustration of a mute control message to be used for the instruction of a mobile radio communications system to mute PTT messages originating from a particular PTT user/PTT client.

FIG. 4 is a schematic illustration of one embodiment of the inventive broadcast interface.

FIG. 5 illustrates a PTT data packet to which a priority label has been added.

FIG. 6 illustrates an example of signalling performed within a mobile radio communication system for the setting up and closing down of a PTT broadcast session.

FIG. 7 illustrates an example of signalling performed within a mobile radio communications system for the announcement of PTT broadcast information.

### DETAILED DESCRIPTION

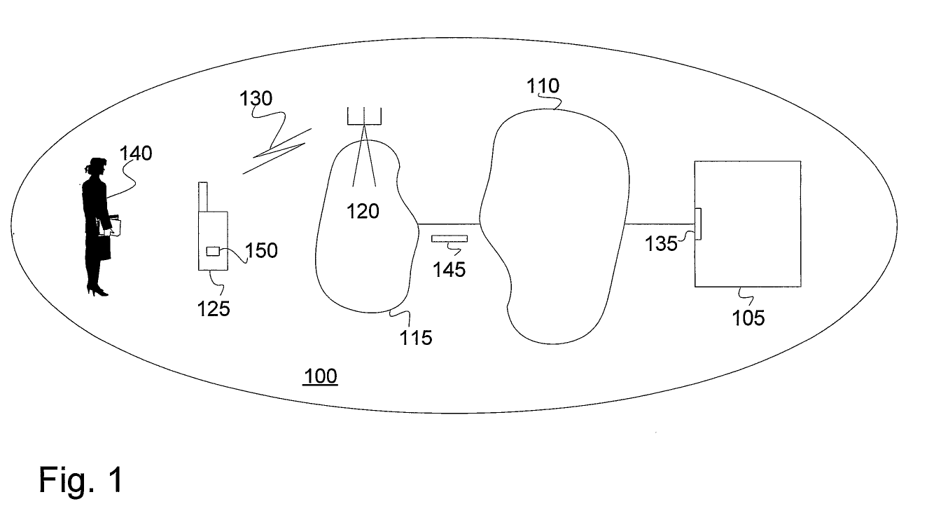

The general architecture of a mobile radio network 100 providing a PTT service is schematically illustrated in FIG. 1. The mobile radio network 100 of FIG. 1 comprises a PTT server 105, a core network 110, an access network 115 and a radio base station 120. The PTT server 105 is connected to the core network 110, which is further connected to the access network 115. Access network 115 is connected to the radio base station 120, which can communication with mobile stations 125 over a radio interface 130. A mobile radio network 100 could comprise several PTT servers 105, although for the sake of simplicity, it will in the following be assumed that only one PTT server 105 is present. For purposes of illustration only, mobile stations 125 will in the following be referred to as PTT clients 125, notwithstanding the fact that most PTT clients 125 support many other communication services than the PTT service.

The PTT service provided by mobile radio network 100 is preferably controlled by the PTT server 105, and the PTT server 105 advantageously comprises an interface 135 for communicating with PTT clients 125. A PTT client 125, communicating within mobile radio network 100 and being adapted to providing the PTT service to its user, can perform one way voice communication within a group of PTT clients 125 forming a PTT user group. A PTT user group can consist of two or more PTT clients 125, and the members of a PTT user group may vary over time. Within a PTT user group, only one PTT user 140 can talk at a time. When a PTT user 140 wants to talk to one or several other PTT users 140, the PTT user 140 uses a PTT client 125 to request a permission to talk. The PTT client 125 comprises software for sending a request for permission to talk. To request permission to talk is often referred to as requesting “the floor”, and the PTT client 125 who presently has the permission to talk is said to occupy the floor. When the floor has been granted to a PTT client 125 by the PTT server 105, the corresponding PTT user 140 can talk to the other PTT users 140 in the PTT user group. A PTT data packet 145, comprising data corresponding to sounds recorded by the PTT client 125 presently occupying the floor, are routed via the PTT server 105 to the other PTT clients 125 that are part of the same PTT user group.

A PTT user 140 can choose to never request the floor, and hence to be a listening user only. However, in order to listen to a discussion held within a PTT user group, a PTT client 125, adapted to provide the PTT service to a user, is still required. Furthermore, radio coverage by a mobile radio network providing the PTT service is also required. Typically, a subscription to the PTT service in the mobile radio network 100 is also required.

According to the present invention, a PTT discussion can be listened to without the prerequisite of a PTT client 125 or a PTT subscription in a mobile radio network 100.

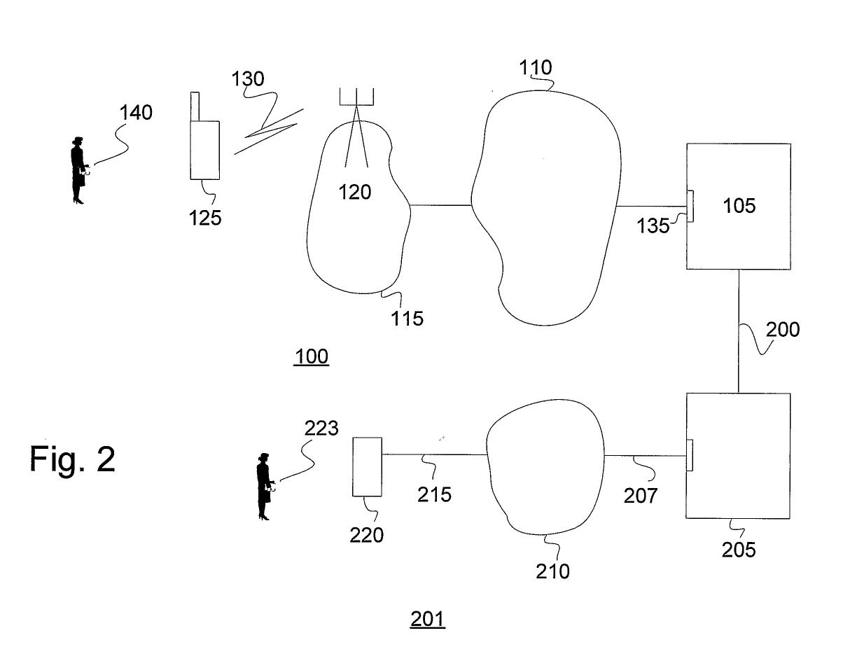

FIG. 2 illustrates a mobile radio communications system 201 comprising the mobile radio network 100 of FIG. 1 and wherein a new interface 200 has been provided between the PTT server 105 and a broadcast node 205. Via the interface 200, hereinafter referred to as the PTT broadcast interface 200, the PTT server 105 can send PTT data packets 145 received from PTT clients 125 to the broadcast node 205. The broadcast node 205 is further connected, via connection 207, to a broadcast distribution network 210, to which the broadcast node 205 can forward PTT data packets 145 received from the PTT server 105. Broadcast node 205 could be part of broadcast distribution network 210, or be a logically separate entity. The broadcast distribution network 210 can then, via a connection 215, send the PTT data packets 145 to one or more clients 220, hereinafter referred to as broadcast clients 220. The broadcast distribution network 210 is a logical entity which can broadcast information, i.e. distribute the same information to a large number of broadcast clients 220. The distribution of the information by a broadcast distribution network 210 is often performed simultaneously to several broadcast clients 220. A session by which PTT data packets relating to a PTT user group is broadcasted to one or several broadcast clients 220 will hereinafter be referred to as a PTT broadcast session. A broadcast client 220 is a client that will receive PTT data packets 145 in a PTT broadcast session while not being able to be active in the PTT broadcast session, i.e. to send PTT data packets 145. The connection 215 connecting the broadcast distribution network 210 to a broadcast client 220 can be wired, or wireless, depending on the transmission protocol used by the broadcast client 220 and the broadcast distribution network 210. A broadcast distribution network 210 could support both wired and wireless transmission, or just one of the two.

The payload of a PTT data packet 145 represents, in binary format, sounds recorded by a PTT terminal 125 while PTT terminal 125 is occupying the floor. A PTT server 105 conventionally uses the real-time transport protocol (RTP) for transmission of PTT data packets 145. The RTP packets are normally encapsulated in UDP/IP (User Data Protocol/Internet Protocol) packets. The protocol referred to as the Session Initiation Protocol (SIP) is used by the PTT server 105 for control plane communication, such as e.g. for setting up push-to-talk sessions.

A PTT user 140 should preferably be given the possibility of controlling whether his contributions to a PTT group discussion are broadcasted or not. This could either be done on a per contribution basis, or in a way so that a particular PTT user 140 can decide that his contributions to the PTT group discussions should never be broadcasted, but should be transmitted to the other PTT users 140 of the PTT group only. A per contribution implementation could for example be implemented by means of a mute button 150 on the PTT client 125, which, when being pressed, triggers the addition of a mute label to any PTT messages 145 sent when the PTT user 140 next time occupies the floor. In this implementation, the broadcast node 205 could comprise software for interpreting the mute label, and for ensuring that any PTT messages 145 which carries a mute label will not be broadcasted by the broadcast node 205. Alternatively, the PTT server 105 could interpret the mute label, and when a mute label indicates that a PTT message 145 should not be broadcasted, the PTT server 105 makes sure that the PTT message 145 is not forwarded to the broadcast node 205. The addition of a mute label could be replaced by the setting of a mute flag of PTT message 145 to a value “mute”. Alternatively, the pressing of the mute button 150 could trigger the sending of a control message from the PTT client 125 to the PTT server 125, or to the broadcast node 205, the control message indicating that the next PTT message 145 from PTT user 140 should not be broadcasted.

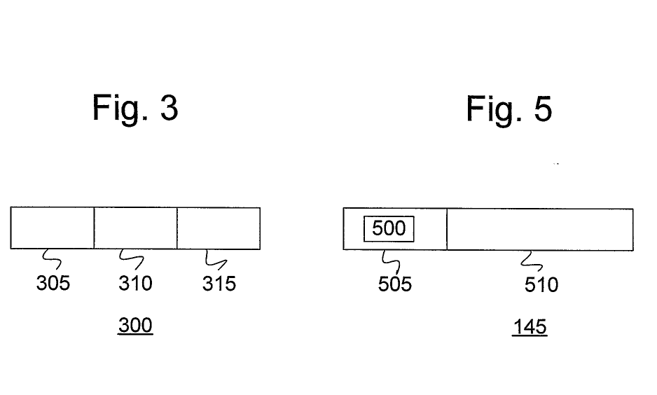

In an implementation where a PTT user 140 can generally decline any broadcasting of his contributions, a predefined pressing of buttons on the PTT client 125 could alter the settings of the PTT client 125 such that the PTT client 125 adds a mute label/sets the mute flag for each PTT message 145 that is being transmitted from the PTT client 125. Alternatively, the pressing of a predefined button on the PTT client 125, or a predefined sequence of button pressings, could trigger the sending of a control message to the PTT server 105 or the broadcast node 205, the control message indicating that no PTT messages 145 from the PTT user 140 should be broadcasted. Such a mute control message could preferably be a SIP message. An example of a mute control message 300 is given in FIG. 3. Mute control message 300 comprises an address field 305 identifying the node to which the mute control message 300 is addressed, a message identification field 310 identifying the mute control message 300 as relating to the muting of PTT messages 145, and a PTT user identity field 315 identifying the PTT user 140/PTT client 225 for which PTT messages 145 should not be broadcasted. Other fields could also be included in mute control message 300. A corresponding end-of-mute control message should preferably also be defined, in order to facilitate for a PTT client 125 to instruct the mobile radio communications system 201 to stop the muting of PTT messages 145 originating from the PTT client 125. In this implementation, the PTT server 105, or broadcast node 205, could hold a storage for storing identities of PTT users 140 whose PTT messages 145 should not be broadcasted. Upon receipt of a mute control message 300, the identity stored in PTT user identification field 315 will be added to the storage for storing identities of PTT users 140 whose PTT messages 145 should not be broadcasted. Upon receipt of a PTT message 145, this storage for storing identities could be checked, and any PTT messages 145 received from PTT users 140 identified in the storage would not be broadcasted.

By allowing the PTT user 140 to decline the broadcasting of his contributions to the PTT group discussions, the privacy of the PTT users 140 is ensured.

Information regarding which broadcast clients 220 which are currently receiving a PTT broadcast session could preferably be stored in the broadcast node 205, or elsewhere. This information could be provided to a PTT client 125 upon request, for example via the short message service (SMS) of mobile radio communications system 201. This gives a PTT user 140 the possibility of checking who may be listening to the current PTT user group discussion.

The invention could be implemented using different types of broadcast distribution networks 210. Broadcast distribution network 210 could for example be a mobile radio network (e.g. the mobile radio network 100 providing the PTT service), a Digital Audio Broadcast (DAB) network, a wireless LAN, a Digital Video Broadcast (DVB) network, a Digital Video Broadcast-Handheld (DVB-H) network or a conventional radio broadcast network, such as e.g. an FM radio network used for public transmission of radio programs. When the broadcast distribution network 210 is a conventional radio broadcast network, the broadcast node 205 comprises software for converting a stream of digitally represented PTT data packets 145 into a format suitable for transmission over the conventional radio broadcast network.

In order for a user 223 of a broadcast terminal 220 to be able to listen to a particular PTT user group, there should preferably be a possibility of tuning the broadcast terminal 220 to a channel used by the broadcast distribution network 210 for the broadcasting of the particular PTT user group. A channel can be seen as the set of physical and higher layer variables that uniquely identify a stream of PTT data packets 145 carrying data originating from a PTT user group and being transported over a connection 215 to a broadcast client 220. The tuning procedure includes the selection of the corresponding physical layer parameters (e.g. frequency in a frequency division multiplexing system, CDMA code in a code division multiplexing system, time slot information in a time slotted system etc) and higher layer parameters such that the desired PTT data packets 145 can be delivered to the broadcast client 145. When the broadcast distribution network is a conventional FM radio network, a channel could correspond to a frequency, and the broadcast client 220 could comprise conventional frequency tuning means.

A broadcast node 205 should have access to information that links a PTT user group to the broadcasting resources (channel) used for the broadcasting of the PTT user group, in order to be able to route the PTT data packets 145 originating from a PTT user group to the correct broadcasting resources. Furthermore, this information could also be used for the announcement of the broadcasting of PTT user groups, as is further discussed below.

The broadcast node 205 can advantageously be a Broadcast-Multicast Service Centre (BM-SC) as defined in 3GPP TS 23.246 “Technical Specification Group Services and System Aspects; Multimedia Broadcast/Multicast service (MBMS); Architecture and functional description” and 3GPP TS 26.346 “Technical Specification Group Services and System Aspects; Multimedia Broadcast/Multicast service; Protocol and Codecs”. A similar node is defined in the corresponding 3GPP2 service Broadcast and multicast service, and the term BM-SC will in the following be used to refer to nodes of both standards. As the name reveals, a BM-SC is capable of both broadcasting and multicasting information. In the following, both broadcasting and multicasting will be referred to as broadcasting, and the invention is equally applicable to both.

The Multimedia Broadcast/Multiservice is a point-to-multipoint service that can be implemented in a mobile radio network such as a GSM or a UMTS network. In the MBMS service, data is transmitted from a single source entity to multiple recipients, and a BM-SC is a functional entity which provides necessary functions for the implementation of MBMS user services. A BM-SC may for example serve as an entry point for content provider transmissions, i.e. a BM-SC may provide a content provider, providing content to MBMS end users, with access to the mobile radio network that the BM-SC is serving. A BM-SC is capable of initiating and terminating MBMS bearer resources prior to and following transmission of content to MBMS end users, providing the mobile radio network that it is serving with transport associated parameters such as quality of service, generating charging records for the transmitted content data, etc. A BM-SC comprises an MBMS session and transmission function which transfers the actual MBMS session data to the group of MBMS user equipments/clients, and which comprises the MBMS delivery methods which use the MBMS bearer service for distribution of content. The BM-SC uses a standardised BM-SC control protocol for the control plane communication with other nodes.

A PTT server 105 is in this implementation of the invention connected to a BM-SC in a manner so that the BM-SC can broadcast PTT data packets 145 to users who do not necessarily have access to a PTT client 125. The BM-SC then acts as a broadcast node 205, and will hereinafter be referred to as BM-SC 205i. The PTT server 105 can then can be seen to serve as a content provider to the BM-SC 205i. However, a PTT server 105 differs from other content providers in that the provided content is transmitted in real time. Furthermore, the content provided by a PTT server 105 is of bursty nature, so that at one moment, the PTT server 105 may provide contents (one or several PTT data packets 145), whereas at the next moment, the PTT server 105 may provide nothing to the BM-SC, and a moment later, one or more PTT data packets 145 may be provided.

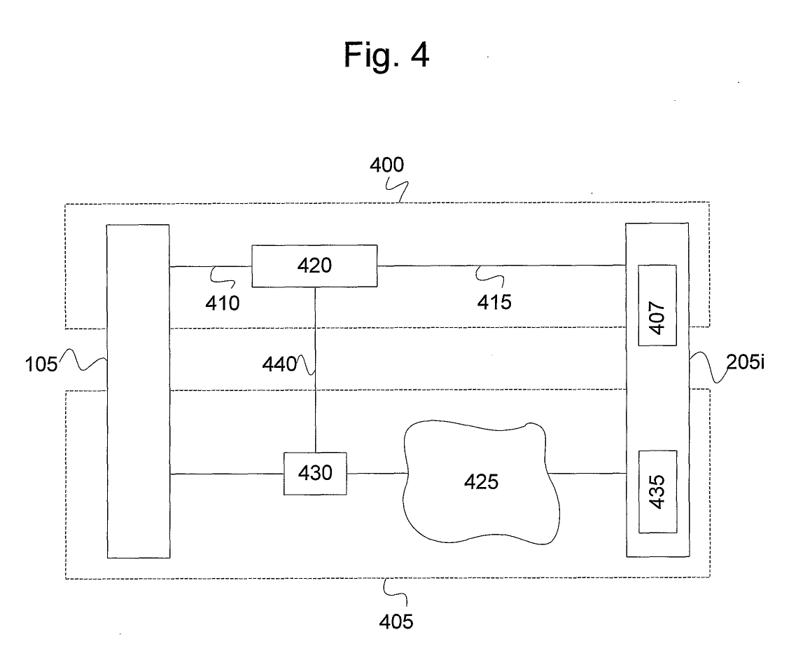

In order to allow for a PTT server 105 to provide contents to a BM-SC 205i, the PTT broadcast interface 200 may be suitably defined for interaction between the PTT server 105 and the BM-SC 205i. In FIG. 4, the control plane part 400 and the user plane part 405 of an example of such a broadcast interface 200 are illustrated. The user plane and control plane communication with PTT server 105 could preferably be handled by the session and transmission function 407 of the BM-SC 205i. The control plane part 400 of the broadcast interface 200 of FIG. 4 comprises a SIP connection 410 for that end of broadcast interface 200 which is closer to the PTT server 105, and a BM-SC control connection 415 for that end of broadcast interface 200 which is closer to the BM-SC 205i. The control plane part 400 further comprises a PTT broadcast protocol conversion unit 420 connecting the SIP connection 410 with the BM-SC control connection 415. The PTT broadcast protocol conversion unit 420 is arranged to convert SIP control messages sent on SIP connection 410 into corresponding BM-SC control messages that can be sent on BM-SC control connection 415 and hence be understood by BM-SC 205i, and vice versa, in order to allow for communication of control messages between the PTT server 105 and the BM-SC 205i. The control messages to be communicated could for example relate to the setting up of a PTT broadcast session, the ending of a PTT broadcast session, the format that should be used for the payload of the PTT data packets 145, the muting of PTT messages 145 as discussed above, etc.

The PTT broadcast protocol conversion unit 420 could be implemented as a separate physical unit, as part of the PTT server 105 or BM-SC 205i, or as part of any other suitable node. The PTT broadcast protocol conversion unit 420 of FIG. 4 only operates on the control plane part of broadcast interface 200. In other implementations of the invention, the PTT broadcast protocol conversion unit 420 could operate on the user plane part of the broadcast interface 200 and could e.g. perform transcoding of PTT data packets 145 from a voice coding format used by the PTT server 105 to voice coding format used by the broadcast node 205.

The user plane 405 of FIG. 4 can advantageously be implemented by use of an IP network 425, which can transport PTT data packets 145 in real time from the PTT server 105 to the BM-SC 205i. By real time is here meant with virtually no, or low, delay (a delay of about 15-20 ms could be acceptable). The transmission on the user plan part 405 of broadcast interface 200 could preferably include the IP/UDP protocol and the RTP protocol.

In order to ensure that the BM-SC 205i forwards any PTT data packets 145 to the broadcast distribution network 210 in real time, PTT data packets 145 could advantageously be marked with a priority label. The priority label could preferably be used in order to indicate to the BM-SC 205i that a received PTT data packet 145 should be given priority over data packets received from other sessions. Furthermore, the priority label could also be used to indicate to the IP network 425 that the PTT data packet 145 should be given priority over other IP packets in the IP network 425. By giving the PTT data packets 145 high priority, the real time transmission of the PTT data packets 145 can be secured. An example of a PTT data packet 145 to which a priority label 500 has been added is given in FIG. 5. In the PTT data packet 145 of FIG. 5, the priority label 500 has been included within the header 505 of PTT data packet 145. When PTT data packet 145 is an IP packet, the priority label 500 could for example be indicated in the “type of service” (ToS) field, or the “traffic class” field. Standard differentiated services IP routers could then be used in an IP network 425, and no alteration of the payload 510 of PTT data packet 145 would be necessary, and hence, more user data could be transmitted in each PTT data packet 145. Since in this implementation, priority label 500 could be included in header 505 in a manner so that IP routers of IP network 425 would recognise the priority label 500 as a priority label, a PTT data packet 145 could be given priority in the IP network 425, as well as in the BM-SC 205i. In an alternative implementation, the priority label 500 could be added as a tail or header to the PTT data packet 145. However, in this implementation, the PTT data packet 145 would not be recognised as an IP packet, and the broadcast interface 200 would have to be a single link between the PTT server 105 and the BM-SC 205i. In yet another alternative, the priority label 500 could be added within the payload 510 of PTT data packet 145, so that the BM-SC 205i would have to unpack the PTT data packet 145 in order to detect the priority label 500. However, in this implementation, any IP routers of IP network 425 would not recognise that the PTT data packet 145 should be given priority. The IP network 425 could alternatively use the IP address of the sender in order to identify the priority of a PTT data packet 145. All PTT data packets 145 originating from the same PTT server 105 would then be given the same priority.

The priority label 500 could be added to PTT data packets 145 by a priority unit 430, which could for example be part of the PTT server 105, part of the PTT broadcast protocol conversion unit 420, or implemented as a separate unit. In a simple embodiment of priority label 500, the priority label 500 is a binary digit, where one value of the binary digit could represent high priority, i.e. a real time PTT data packet 145, and another value could represent low priority, i.e. a data packet from another content provider. Alternatively, the presence of a priority label 500 could indicate a real time PTT data packet 145, whereas the absence of a priority label 500 could indicate a best effort data packet that does not require real time transmission.

In another embodiment, the priority label 500 can take a plurality of values. This can for example be advantageous for indicating to the BM-SC 205i the PTT broadcast session to which a particular PTT data packet 145 is associated, for indicating that a particular PTT data packet 145 originates from a PTT user 140 of particular status (e.g. a leader of the PTT user group), for indicating that a PTT data packet 145 comprises an emergency message, etc. The different possible values of the priority label 500 could also include values representing the mute label discussed above. In this embodiment, an interface 440 between the control plane part 400 and priority node 430 could advantageously be established, which is illustrated in FIG. 4 by interface 440 connecting the priority unit 430 with the protocol conversion unit 420. Alternatively, the provision of this information to the priority unit 430 could be handled by another entity.

Interface 440 could be used for installing PTT broadcast session related state information in the priority unit 430. The state information installed in the priority unit 430 could be part, or all, of the Session Description Protocol (SDP) information that is carried in the SIP signalling relating to the PTT broadcast session, and is stored together with an identifier which identifies the PTT broadcast session to which the state information relates. The session description protocol is specified in Internet Engineering Task Force (IETF) document RFC 2327. The SDP information carried in the SIP signalling could for example include information on which priority should be given to PTT data packets 145 of the session (which could be user specific), IP addresses relevant to the session, port numbers, codecs used to create voice samples (e.g. pulse code modulation), URL (Uniform resource locators) identifying websites where more information on the topic of the session can be retrieved, etc. A PTT data packet 145 which is received by the priority unit 430 for further delivery to the BM-SC 205i comprises an identifier which identifies the PTT broadcast session from which the PTT data packet 145 originates. Hence, the state information stored in priority unit 430 relating to this PTT broadcast session, such as priority information, could be applied by priority unit 430 to the PTT data packet 145.

In order for the BM-SC 205i to be able to interpret the priority label 500, the BM-SC 205i should preferably have a priority label interpretation unit 435, adapted to interpret priority label 500. Priority label interpretation unit 435 could preferably be part of the BM-SC 205i, or be implemented as a separate physical unit. In an embodiment in which the representation of the different values of the priority label 500 varies, the priority label interpretation unit 435 could have a connection similar to connection 440, by which priority label interpretation unit 435 could be provided with information relating to the interpretation of the priority label 500.

With a priority label 500 capable of taking a plurality of values, different values could indicate different levels of priority. However, in many cases, the PTT broadcast sessions to which the different values are associated should be given the same level of priority by the BM-SC 205i. Hence, the priority level could be indicated by a simple, binary priority label 500, whereas the session information could be indicated by a separate session information label.

In FIG. 4, the control plane part 400 and the user plane part 405 are shown to use different connections. Needless to say, in an implementation of the invention, the control plane part 400 and the user plane part 405 could use the same physical connections (which could e.g. be an IP based core network of the mobile network operator).

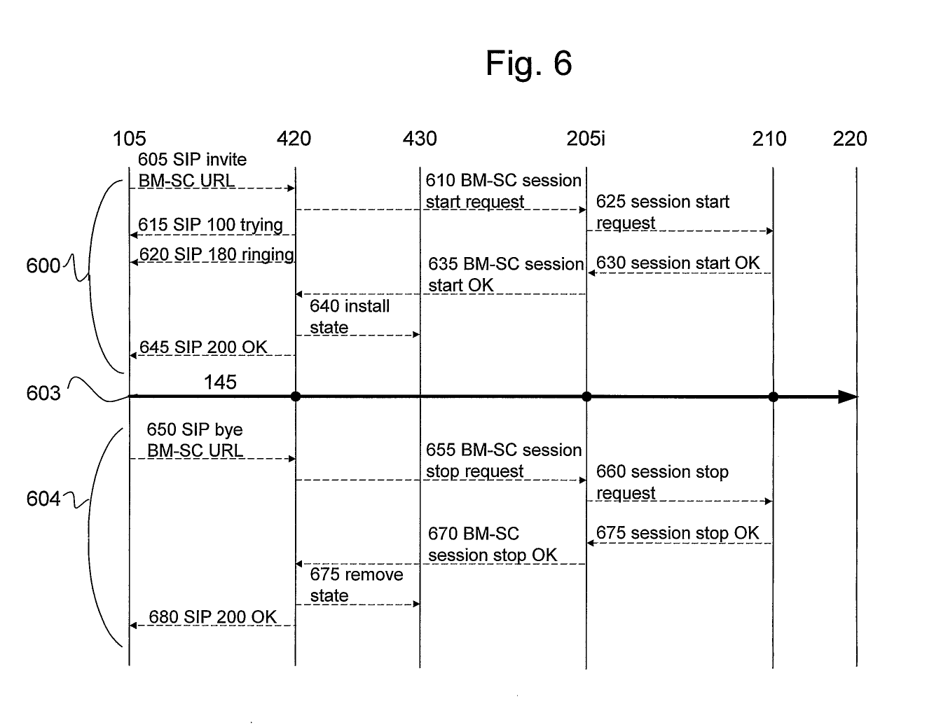

FIG. 6 illustrates an example of signalling related to a PTT broadcast session and performed between the PTT server 105 and BM-SC 205i of FIG. 4 via a PTT broadcast protocol conversion unit 420. The control plane entities of the signalling illustrated in FIG. 6 are the PTT server 105, the PTT broadcast protocol conversion unit 420, the BM-SC 205i and the broadcast distribution network 210. The control plane signalling of FIG. 6 are illustrated by use of broken lines. The illustrated signalling includes a first set 600 of control messages associated with the setting up of a PTT broadcast session, the delivery 603 of PTT data packets 145, and a second set 604 of control messages associated with closing down of the PTT broadcast session. The first set 600 of control messages illustrates an example of the setting up of a PTT broadcast session between the PTT server 105 and the BM-SC 205i. A “SIP Invite BM-SC URL” message 605 is sent over the SIP connection 410 from the PTT server 105 to the PTT broadcast protocol conversion unit 420. The “SIP Invite BM-SC URL” message 605 is converted by PTT broadcast protocol conversion unit 420 into a corresponding “BM-SC Session start request” message 610 and sent to the BM-SC 205i over the BM-SC control connection 415. The PTT broadcast protocol conversion unit 420 also sends a “SIP 100 trying” message 615 and a “SIP 180 ringing” message 620 to the PTT server 105, in order to indicate to the PTT server 105 that the “SIP Invite BM-SC URL” message 605 has been acted upon.

Upon receipt of the “BM-SC session start request” message 610, the BM-SC 205i allocates broadcast distribution network specific identifier(s)/resources to the relevant PTT user group, and sends a “session start request” message 625 to the broadcast distribution network 210 over connection 207, using an appropriate protocol. The “Session start request” message 625 received by the broadcast distribution network 210 triggers the broadcast distribution network 210 to allocate resources for the transfer of PTT data packets 145. A “session start OK” message 630 is then sent from the broadcast distribution network 210 to the BM-SC 205i and forwarded by the BM-SC 205i to the PTT broadcast protocol conversion unit 420 over the BM-SC control connection 415 as a “BM-SC session start OK” message 635. The “BM-SC session start OK” message 635 is converted by the PTT broadcast protocol conversion unit 420 into a corresponding “SIP 200 OK” message 645 sent over the SIP connection 410. In the implementation of the invention illustrated by FIG. 6, the receipt of the “BM-SC session start OK” message 635 by the PTT broadcast protocol conversion unit 420 triggers the PTT broadcast protocol conversion unit 420 to send an “install state” message 640 to the priority unit 430, in order to install the state in the priority unit 430, as discussed above.

The delivery 603 of PTT data packets 145 from the PTT server 105 to the broadcast client 220 can performed by use, for example, of the RTP protocol over IP network 425 for streaming, or, for example, by the FLUTE (File Delivery over Unidirectional Transport) protocol for download, or by any other suitable protocol. In FIG. 6, a dot on the line illustrating a user plane entity shows that this user plane entity is involved in the delivery 603 of PTT data packets 145. This applies to the PTT server 105, priority unit 420, BM-SC 205i, broadcast distribution network 210 and the broadcast terminal 220. The priority unit 420 adds a priority label 500 to the PTT data packets 145 in the embodiment illustrated by FIG. 6.

The second set 610 of control messages for closing down the PTT broadcast session comprises a “SIP bye BM-SC URL” message 650 sent from the PTT server 105 to the PTT broadcast protocol conversion unit 420, a “BM-SC session stop request” message 655 sent from the PTT protocol conversion unit 420 to the BM-SC 205i in response to the “SIP bye BM-SC URL” message 650 and a “session stop request” message 660 sent from the BM-SC 205i in response to the “BM-SC session stop request” message 655. Upon receipt of the “session stop request” message 660, the broadcast distribution network 210 disengages the resources allocated to the PTT broadcast session to be closed down. A “session stop OK” message 665 is then sent from the broadcast distribution network 210 to the BM-SC 205i, which sends a “BM-SC session stop OK” message 670 to the PTT broadcast protocol conversion unit 420. In response to receiving this message, the PTT broadcast protocol conversion unit 420 sends a “SIP 200 OK” message 680 to the PTT server 105, and a “remove state” message 675 to the priority unit 430.

In the signalling example illustrated by FIG. 6, the PTT server 105 initiates the PTT broadcast session by sending an “invite BM-SC URL” message. In other instances, the PTT broadcast session could be initiated by the BM-SC 205i. This could for example be advantageous if the number of broadcast clients 220 is much smaller than the number of PTT clients 125, so that there is a large risk of there being no active broadcast clients 220 who would listen to the PTT broadcast session. The BM-SC 205i could then initiate the PTT broadcast session when a sufficient number of broadcast client 220 becomes active. A trigger could be implemented in the BM-SC 205i for triggering the sending of a message to the PTT server 105 regarding the initiation of a PTT broadcast session when the number of active broadcast clients 220 has exceeded a predefined number, e.g. 1. This trigger could e.g. be a counter for counting the active broadcast clients 220. Similarly, the closing down of the PTT broadcast session could be initiated by the BM-SC 205i.

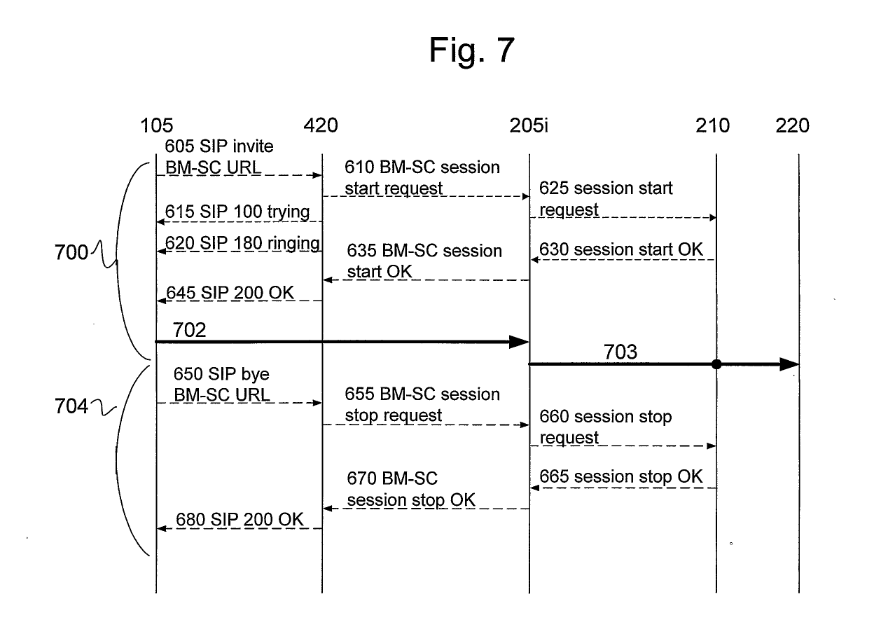

In order for a broadcast user 223 of a broadcast distribution network 210 to find out which PTT user group sessions are being broadcasted and which channels are used for the broadcasting, channel information should preferably be announced. This could be done in a push or a pull scenario. The broadcast distribution network 210 could for example the push the channel information to the broadcast clients 220, or the broadcast client 220 could pull the channel information from e.g. an IP core network of the mobile network operator. An example of a push announcement session for the announcing of PTT broadcasting services via the broadcast distribution network 210 in an embodiment where the broadcast node 205 is a BM-SC 205i is illustrated in FIG. 7. A first set 700 of control messages are used to set up an announcing session. The first set 700 of FIG. 7 includes the same signalling as the first set 600 of FIG. 6, except that no “install state” message 640 is sent. When the PTT server 105 receives the “SIP 200 OK” message 645, which signals that a session has been started, PTT server 105 sends a “PTT information” message 702 to the BM-SC 205i. The “PTT information” message 702 comprises information relating to the PTT user group(s) that is/are to be announced. Such information could for example be an identity of the PTT user group(s), identities of the PTT users 140 that are presently active in the PTT user group(s), how many messages that have already been exchanged in the PTT user group(s), for how long the PTT user group has been active, etc. The “PTT information” message 702 could for example be a SIP message, or a new protocol comprising the “PTT information” message 702 could be defined. The message 702 could alternatively be transported by use of the FLUTE protocol.

Having received the PTT information message 702, the BM-SC 205i links the PTT user group(s) to be announced to resources that are to be/has been allocated to the PTT user group(s), and sends an announcement message 703 to the relevant broadcast clients 220. The announcement message 703 comprises information on the PTT user group(s) that is/are (to be) broadcasted, as well as information identifying the channel(s) on which the PTT user group(s) will be/are broadcasted. Other information could also be included in announcement message 703, such as for example identifications of the PTT users 140 taking part in the PTT user group(s). An identifier of the PTT user group which could be used for joining the PTT user group, such as e.g. a telephone number, could preferably be broadcasted by the broadcast node 205. This identifier could, if desired, be used by a broadcast user 223 who wishes to join the PTT user group as a PTT user 140 via a PTT enabled client 220/125.

The announcement message 703 could advantageously be transmitted by use of the FLUTE protocol, although any suitable protocol may be used.

A second set 704 of control messages is used in FIG. 7 for the closing down of the announcement session set up by the set 700 of control messages. The second set 704 of FIG. 7 includes the same signalling as the second set 604 of FIG. 6, except that no “remove state” message 675 is sent. Upon receipt of the “session stop request” message 660, the broadcast distribution network 210 releases the resources allocated to the announcement session. The second set 704 of control messages could for example be triggered by inactivity of the PTT user group or by the expiry of a timer.

The announcement session of FIG. 7 is initiated by the PTT server 105. This facilitates for the announcement to be dynamic, since the PTT server 105 has information about whether any PTT users 140 are presently active, whether there are any active PTT users 140 who have applied the mute functionality discussed above, etc. However, an announcement session for the announcement of broadcast service could alternatively be initiated by the BM-SC 205i. BM-SC 205i could store information regarding the available PTT user groups and the corresponding channels that are used for the broadcasting of the PTT user groups, making the exchange of information between the PTT server 105 and the BM-SC 205i of FIG. 7 superfluous. Furthermore, an announcement session could alternatively be terminated by the BM-SC 205i, regardless of whether the PTT server 105 or the BM-SC 205i initiated the announcement session.

In the embodiment of the signalling diagrams FIGS. 6 and 7, the broadcast node 205 is a BM-SC 205i. However, in implementations where the broadcast node 205 is another type of node, such as for example a service application node of a DVB-H network, similar signalling diagrams could be applied.

If necessary, messages transmitted on the connection between the broadcast node 205 and the broadcast distribution network 210 could undergo a protocol conversion. A unit capable of converting messages formatted according to the protocol used by the broadcast node 205 and the broadcast distribution network 210 could preferably be included in the mobile radio communication system 201.

The invention could be implemented such that the broadcast distribution network 210 is a mobile radio network. For example, when the broadcast node 205 is a BM-SC, the broadcast distribution network 210 could be a mobile radio network in which the Multimedia Broadcast/Multicast service (MBMS) is implemented. Hence, the mobile radio network 100 providing the PTT service to PTT clients 125 and the broadcast distribution network 210 broadcasting PTT broadcast sessions to broadcast clients 220 could be the same. The broadcast clients 220 would not have to be PTT enabled clients, but could be clients that are merely MBMS enabled. The connection 207 between the broadcast node 205 (BM-SC) and the broadcast distribution network 210 could in this implementation advantageously be the standardised Gmb-interface, which is defined in 3GPP TS 23.256.

A broadcast node 205 could simultaneously forward the PTT data packets 145 to one or more broadcast distribution networks 210, such as to the mobile radio network 100 and to a wireless LAN. Broadcast clients 220 operating according to different standards can then simultaneously follow a PTT discussion transmitted by the broadcast node 205. Alternatively, a PTT server 105 could be connected, via broadcast interfaces 200, to more than one broadcast node 205, the broadcast nodes 205 being connected to different broadcast distribution networks 210.

In applications of the invention where the broadcasting of the PTT data packets 145 corresponding to discussions held within a PTT user group does not have to be performed in real time, but where a delay is acceptable for the broadcasting of the PTT broadcast session, the mobile radio communications system 201 could comprise storage for storing PTT data packets 145. PTT server 105 could then send PTT data packets 145 to the storage for storing, and the stored PTT data packets 145 could be retrieved by broadcast node 205 at a later point in time. The storage for storing PTT messages 145 could be located in the PTT server 105, in the broadcast node 205, or elsewhere. The storage of PTT messages 145 for playback at a later point in time is advantageous in that silent moments, when no PTT user 140 is talking, or when a PTT user 140 that has declined his contributions being broadcasted, can be filtered out. The broadcasting of the PTT data packets 145 could in this implementation be performed to all broadcast clients 220 which are tuned to the broadcast channel at the time of broadcasting. Alternatively, the transmission of the stored PTT data packets 145 to a client could be performed on demand.

In the above, the invention has been described in terms of the push-to-talk service. However, the invention is applicable to any push-to service in which push-to data packets 145 are transmitted in a one-way communication fashion from a push-to user 140 to a group of other push-to users 140. The push-to-talk service is an example of a push-to service, in which a push-to data packet 145 is a push-to-talk data packet comprising data representing sounds. Another example of a push-to service is the push-to-watch service, in which the transmitted push-to data packets 145 comprise data representing visual data.

One skilled in the art will appreciate that the present invention is not limited to the embodiments disclosed in the accompanying drawings and the foregoing detailed description, which are presented for purposes of illustration only, but it can be implemented in a number of different ways, and it is defined by the following claims.

1. A method of communicating a push-to data packet within a communications system, the push-to data packet originating from a push-to client participating in a push-to user group comprising at least two push-to clients, comprising:
receiving the push-to data packet from a push-to server; and
broadcasting the push-to data packet over a broadcast distribution network to broadcasting clients which are not part of the push-to user group.

2. The method of claim 1, further comprising providing the push-to data packet with a priority indication, the priority indication indicating a level of priority which should be given to the push-to data packet when being broadcasted.

3. The method of claim 2, wherein the push-to data packet is received over a communications interface having a user plane part and a control plane part, the method further comprising:
sending an install state message from the control plane part to the user plane part, the install state comprising information about a push-to session of the push-to user group;
installing the session state in the user plane part; and
associating the push-to data packet with the session state.

4. The method of claim 3, wherein the providing the push-to data packet with a priority indication comprises the association of the push-to data packet with the session state.

5. The method of claim 1, wherein the method comprises:
receiving a control message which is related to the broadcasting, the control message being formatted according to a first protocol used by the push-to server for the transmission of control messages;
converting the control message into a second control message formatted according to a second transmission protocol used by a broadcast node arranged to broadcast the push to data packet via the broadcast distribution network; and
sending the second control message to the broadcast node.

6. The method of claim 5, wherein the first transmission protocol is the Session Initiation Protocol.

7. The method of claim 1, further comprising checking whether the push-to data packet should be broadcasted.

8. The method of claim 1, wherein the method further comprises storing the push-to data packet in a storage for push-to data packets upon receipt of the push-to data packet; and wherein the broadcasting comprises retrieving the push-to data packet from the storage.

9. A control data communication unit having a first port arranged to receive from a first node a first control message formatted according to a first protocol used by the first node for the transmission of control messages; a protocol conversion mechanism arranged to convert the first control message into a second control message formatted according to a second protocol used by a second node for the transmission of control messages: and a second port for sending the second control message to the second node, wherein
the first node is a push-to server;
the control message relates to the broadcasting of a push-to data packet originating from a push-to client participating in a push-to user group comprising at least two push-to clients; and
the second node is a broadcast node arranged to broadcast the push-to data packet to broadcasting clients which are not part of the push-to user group.

10. The control data communication unit of claim 9, wherein the control messages relate to the setting up of a push-to broadcast session of the push-to user group.

11. The control data communication unit of claim 9, wherein the control message relates to the setting up of an announcement session wherein information relating to a push-to broadcast session will be broadcasted by the broadcast node.

12. The control data communication unit of claim 9 further comprising a mechanism for sending an install state message to a user plane node of the communications interface, wherein the install state message comprises information on a state of a push-to session of the push-to user group.

13. A user data communication unit having a first port arranged to receive a user data packet from a first node and a second port arranged to send the user data packet to a second node wherein the user data packet is a push-to data packet originating from a push-to client participating in a push-to user group comprising at least two push-to clients, the first node is a push-to server and the second node is a broadcast node arranged to broadcast the push-to data packet to broadcasting clients which are not part of the push-to user group.

14. The user data communication unit of claim 13, further comprising a priority indication mechanism arranged to add a priority label to the push-to data packet, the priority label indicative of the level of priority that should be given to the push-to data packet over other communicated data packets.

15. The user data communication unit 13, further comprising a priority interpretation mechanism adapted to determine the priority of the push-to data packet.

16. The user data communication unit of claim 13, further comprising a mechanism adapted to receive an install state message from a control plane part of the communications interface, and to install a state in accordance with information contained in the install state message.

17. The user data communication unit of claim 13, further comprising a checking mechanism for checking whether or not a push-to data packet should be broadcasted.

18. The user data communication unit of claim 13 wherein the mobile radio communications system comprises storage for storing push-to data packets; and a mechanism for broadcasting the push-to data packets to the broadcasting clients on demand.

19. A communications interface arranged to communicate push-to data packets, originating from a push-to client participating in a push-to user group comprising at least two push-to clients, from a push-to server to a broadcast node arranged to broadcast the push-to data packets to broadcasting clients which are not part of the push-to user group, wherein the communications interface comprises a protocol conversion unit according to claim 9 and a user data communication unit according to claim 14.

20. A mobile station arranged to send push-to data packets to a push-to server for further distribution within a push-to user group, comprising a mute mechanism arranged to receive a first instruction that a push-to data packet should not be broadcasted to any broadcast client which is not part of the push-to user group and to send a second instruction to the push-to server that the push-to data packet should not be broadcasted.

21. The push-to client according to claim 20 arranged to send the second instruction to the push-to server in a control message.

22. The push-to client according to claim 20 arranged to send the second instruction to the push-to server as an indication in the push-to data packet that is to be muted.
